(19) United States
(12) Patent Application Publication
(10) Pub. No.: US 2013/0273506 A1
(43) Pub. Date: Oct. 17, 2013

(54) Automated Food Intake Data Acquisition And Monitoring System

(71) Applicant: Stephanie Melowsky, White Plains, NY (US)

(72) Inventor: Stephanie Melowsky, White Plains, NY (US)

(21) Appl. No.: 13/447,659

(22) Filed: Apr. 16, 2012

(51) Int. Cl. G09B 19/00

(52) U.S. Cl. 434/127

(57) ABSTRACT

A system and method for collecting food intake related information, processing the information into a caloric value, and recording and reporting the value is provided. The system includes an electronic device having a sensor, an input device, a display, processor, memory, and code modules executing in the processor for implementation of the method. Information concerning the swallowing of food is collected. Weighting factors related to the caloric concentration of the food being ingested are also collected. The caloric value of the users eating is computed by the processor by combining the swallow data with weighted parameters in accordance with an algorithm. The caloric value is recorded in a user's profile and notifications can be generated based on the caloric value and a historical record of food intake information can be maintained and provided to the user via a portal such as a smart phone device or the internet.

### BACKGROUND

In today's society that has an increasing proportion of individuals who are watching their weight or faced with physical challenges that require a strict diet regimen, monitoring food intake has become an important aspect to maintaining a healthy lifestyle.

People who are watching their weight have the daily challenge of maintaining a healthy and balanced calorie intake. Often, dieters are not consuming enough calories in comparison to the amount of energy that they are burning. This can be caused by many things, such as not eating enough food, over-exercising or not eating the right food. Not consuming enough calories can lead to unhealthy losses in weight and can be physically detrimental to the human body or have other unwanted side effects such as being left with excessive extra skin when the skin doesn't have enough time to regain its elasticity. Other dieters can be under the impression that they are maintaining a healthy food intake but still consume too many calories to lose weight. This can be from eating too much, or eating foods that are too high in fat, carbohydrates etc.

In order to maintain the proper food intake, many people resort to calorie counting using food journals. One example of a well known weight loss and calorie counting program is Weight Watchers. Food journals are maintained in a physical book or more recently with a computer. With food journals, the user must manually input and record details about their daily food intake and maintaining an accurate and complete journal requires diligence and a great deal of time and effort. Another drawback to food journals is that the feedback loop whereby a user realizes that they have exceeded their calorie intake limit, or are too far below the limit, is rather long. This can happen when the dieter does not input their food intake immediately before eating. An additional challenge with calorie counting using a food journal is that the calorie value of a particular meal is standardized, for example, a ham sandwich is assigned a particular value. However, it is clear that not all ham sandwiches are alike and one may be bigger than another and therefore have a higher total calorie value. Such inconsistencies lead to inaccurate results when the total calorie intake is calculated.

It can be appreciated that an automated calorie intake counting, monitoring and notification system that is accurate and can be implemented with minimal user input is desired in the art. It is with respect to these and other considerations that the disclosure made herein is presented.

### SUMMARY

According to one embodiment a calorie monitoring system is provided comprising: a swallow sensor configured to detect human swallow events and generate swallow event data;

a user interface configured to receive a user input and generate weighting factors relating to the intrinsic caloric value of food; a memory arranged to store swallow event data and to store weighting factors; a processor arranged to process the stored data by executing code to transform the weighting factors and the swallow event data into a calorie intake value in accordance with an algorithm and store the calorie intake value in memory; and the processor being further arranged to maintain, in memory, a profile of swallow event data, weighting factors and calorie intake values.

According to a further aspect of the embodiment, the system can include a portal arranged to publish the profile of calorie intake values. The portal can be a smart phone application or a web based application. According to a further aspect of the embodiment the system can include a communication interface. According to a further aspect of the embodiment, the system can include a feedback device configured to generate an alert when the calorie intake value reaches a pre-determined value. According to a further aspect of the embodiment, the system includes two or more weighting factors that correspond to the caloric concentration of food. According to a further aspect of the embodiment, the user interface can be a touch screen device.

According to a further aspect of the embodiment, the swallow sensor can be a strain gauge operatively connected to a band worn around a user's neck that generates data during a human swallow event. The swallow sensor can also be a switch that is triggered by the expansion of a user's neck during a human swallow event. The swallow sensor can also be accelerometer that captures movement data relating to the movement of a throat during a human swallow event. The swallow sensor can also be an audio sensor that captures sound data during a human swallow event.

According to an aspect of the present invention, there is provided a computer implemented method for monitoring calorie intake of a person. This method comprises receiving data into a memory on a one or more human swallow events; receiving weighting factors into memory on the intrinsic caloric concentration of food; processing the received data by executing code in a processor that configures the processor to apply the weighting factors to the data relating to the one or more human swallow events and generate a caloric value for one or more human swallow events; storing the caloric value to memory; maintaining a profile with previously captured received data in the memory; generating a notification when the caloric value reaches a pre-determined value; and providing the profile to the user through a portal.

Various features, aspects and advantages of the invention can be appreciated from the following Description of Certain Embodiments and the accompanying Drawing Figures.

### DESCRIPTION OF THE DRAWING FIGURES

FIG. 1 is a network diagram according to one embodiment; and

FIG. 2 is a schematic flow diagram according to one embodiment.

### DETAILED DESCRIPTION OF CERTAIN EMBODIMENTS

The following detailed description, which references to and incorporates the drawings, describes and illustrates one or more specific embodiments. These embodiments, offered not to limit but only to exemplify and teach what is described, are shown and described in sufficient detail to enable those skilled in the art to practice the invention. Thus, where appropriate, the description may omit certain information known to those of skill in the art.

By way of overview and introduction, herein is described a system in which data acquisition, data storage, and data processing are used to calculate calorie intake as a basis for tracking the food intake of a user. In particular, an automated system that implements a sensor that detects when a user swallows while eating, an interface where the user can input the caloric concentration of the food being consumed, and a processor to calculate and record an approximation of the number of calories being consumed by the user. The system can also include a notification device to alert the user when a pre-determined number of calories have been consumed in a particular time-frame (i.e. a sitting or a day, week, month etc.) and a user interface or portal to publish the food intake information so it can be reviewed by the user.

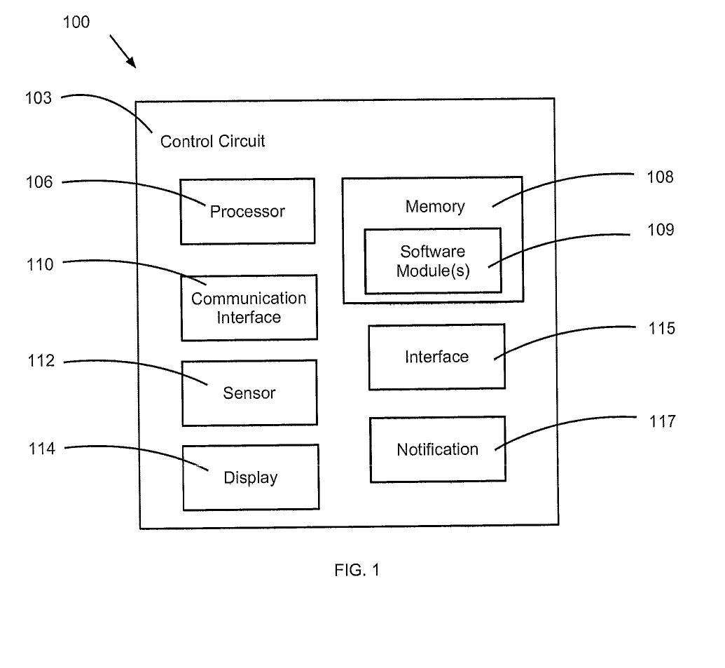

Referring to FIG. 1, in one implementation, a system 100 for counting the calorie intake of a person includes a control circuit 103 which is operatively connected to various hardware and software components that serve to enable determination of calorie intake of a person, as discussed in greater detail below. The control circuit 103 is operatively connected to a swallow sensor 112, a user interface 115, a processor 106, memory 108 and a communication interface 110.

In one embodiment, memory 108 is accessible by processor 106, thereby enabling processor 106 to receive and execute instructions stored on memory 108. Memory 108 can be, for example, a random access memory (RAM) or any other suitable volatile or non-volatile computer readable storage medium that is operatively connected to the control circuit 103, even if not oriented on the control circuit as depicted in FIG. 1.

One or more software modules 109 are encoded in memory 108. The software modules 109 can comprise a software program or set of instructions executed in processor 106. In certain embodiments, software modules 109 can include a user input module and a sensor module and a calorie counting module. The software modules 109 make up a food intake monitoring application that collects data and can calculate calorie intake, and perform other functions, that is executed by processor 106, as discussed in greater detail below. During execution of the software modules 109, the processor 106 is configured to gather information about the person and the person's eating, as discussed in greater detail below.

Sensor 112 is operatively connected to the control circuit 103 and processor 106. Sensor 112 is worn on, around or near the user's neck and gathers data relating to a person swallowing. A processor 106 executing software configures sensor 112 to gather data relating to a person swallowing and stores the data to memory 108 where it is accessible for further analysis by processor 106 executing one or more software modules.

An interface 115 is also operatively connected to control circuit 103. The interface 115 in certain embodiments includes one or more input device(s) such as a switch, knob, button(s), key(s), touch screen, etc. Interface 115 serves to facilitate the capture of certain information about the food being eaten, such as caloric concentration of the food, from the user, as discussed in greater detail below. Interface 115 also serves to facilitate the capture of other information and commands from the user such as an on-off commands or settings related to operation of the calorie counter 100.

The display 114 includes a screen or any other such presentation device which enables the user to view various options and parameters, and results. By way of example, display 114 can be a digital display such as a segment display, a dot matrix display or other 2-dimensional display.

By way of example, interface 115 and display 114 can be integrated into a touch screen display. Accordingly, the display 114 is used to display a graphical user interface, which can display various data and provide “forms” that include fields that allow for the entry of additional information by the user. Touching the touch screen interface 115 at locations corresponding to the display of a graphical user interface allows the person to interact with the device to enter data, change settings, control functions, etc. So, when the touch screen is touched, interface 115 communicates this change to control circuit 103, and settings can be changed or user entered information can be captured and stored in the memory 108.

Communication interface 110 is also operatively connected to control circuit 103. Communication interface 110 can be any interface that enables communication between the control circuit 103 and external devices, machines and/or elements. In certain embodiments, communication interface 110 includes, but is not limited to, a radio frequency transmitter/receiver (e.g., Bluetooth, cellular, NFC), an infrared port, a USB connection. Such connections can include a wired connection or a wireless connection though it should be understood that communication interface 110 can be practically any interface that enables communication to/from the control circuit 103.

Notification unit 117 is also operatively connected to control circuit 103. Notification unit 117 can be any type of unit that generates an attention getting signal including but not limited to a light, a vibration generator or a speaker, and is used to alert the user when a particular event occurs.

It should be understood that while the various hardware and software components referenced herein, including but not limited to 103, 106, 108, 110, 112, 114, 115, 117 are referred to herein as individual/single devices and/or machines, in certain implementations the referenced devices and machines, and their associated and/or accompanying operations, features, and/or functionalities can be arranged or otherwise employed across any number of devices and/or machines, such as over a wireless connection, as is known to those of skill in the art.

By example, sensor 112 can be physically separate from the remaining components such that it can be worn close to the neck of the user yet remain in communication with the control circuit 103. Furthermore, control circuit 103 and the other components of the calorie counter 100 can be employed across a smart phone device. In such an example, the sensor 112 can be in wireless communication with the smart phone. The processor 106 on the smart phone executes the one or more software modules 109 which are stored in memory 108 and displays information on the display 114 of the smart phone. The user can interact with the calorie monitor 100 using the smart phone interface 115 including buttons and/or a touch screen. Furthermore, notification unit 117 can be one or more of the vibrating mechanism, the speaker, lights or the display of the smart phone.

Calorie monitor 100 or one or more components, including but not limited to 103, 106, 108, 110, 114, 115, 117, can be incorporated into an ornamental accessory. The calorie monitor 100 can be embellished with ornaments or can be incorporated into an accessory such as a necklace or a necktie. Alternatively the calorie monitor can be incorporated into a garment such as a shirt or a turtleneck. The calorie monitor 100, or the one or more components that are worn near the neck of the user can be of an appropriate size, such as 1″ by 1″ by 0.5″ and can be obscured from view when in use. By example, the calorie monitor can be a locket that can be opened by the user when the user desires to interact with the calorie monitor 100 otherwise it can be closed and is hidden from view.

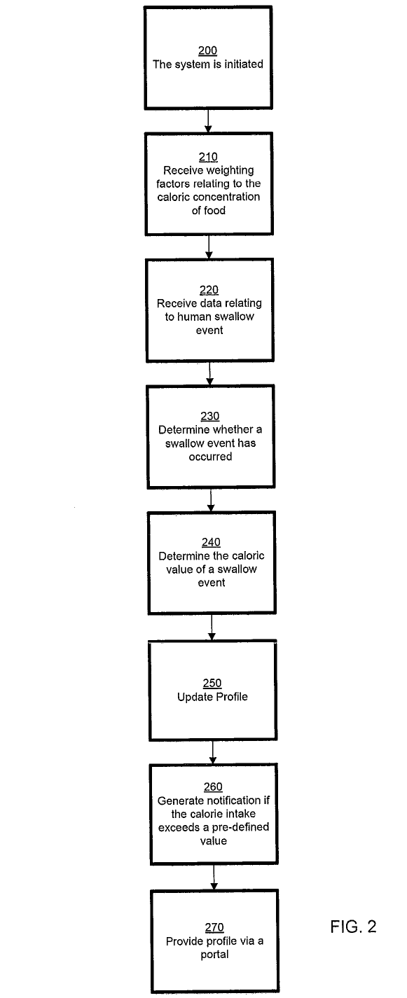

Referring now to FIG. 2, a schematic flow diagram according to one embodiment of the invention is described in support of the measurement of a person's (e.g., a user) calorie intake. It should be appreciated that several of the logical operations described herein are implemented (1) as a sequence of computer implemented acts or program modules running on calorie monitor 100 and/or (2) as interconnected machine logic circuits or circuit modules within the calorie monitor 100. The implementation is a matter of choice dependent on the requirements of the device (e.g., size, energy, consumption, performance, etc.). Accordingly, the logical operations described herein are referred to variously as operations, structural devices, acts, or modules. Various of these operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

At step 200, a person initiates the calorie monitor 100 for the collection, processing and publishing of food intake related data. For example, a person using the calorie monitor 100 can initiate the calorie monitor 100 by switching it on by interacting with interface 115. In certain embodiments, a person can initiate the system prior to commencing eating by pushing an “On/off” button. The processor 106, executing one or more software modules 109 including the user input module is configured to detect a user interaction with the interface 115, interpret the user input and execute commands accordingly. The calorie monitor 100 can also include a pause functionality, whereby the user can temporarily pause the device, if they take a break from eating or are swallowing a sip of water etc. The user can later re-initiate the calorie monitor interacting with the interface 115.

At step 210, the user can set the weighting factor which corresponds to the caloric concentration of the food that they are eating using the user interface 115. The processor 106, executing one or more software modules 109 including the user input module, is configured to detect a user interaction with the interface 115 and store the user input in memory 108 and execute any further commands based on the user input. By way of example, interface 115 can include a two state switch to set the caloric concentration of the food being consumed by the user. Stage 1 of the switch can correspond to a high caloric concentration food (i.e. something high in calories like a cheeseburger) and stage 2 of the switch can correspond to a low caloric concentration food (i.e. a low calorie food like a mixed salad). It can be appreciated that any number of different weighting factors are possible, and is not limited to the described high/low caloric concentration categorization. In certain embodiments, the system can include between 2 weighting factors and 10 weighting factors. It can also be envisioned that the weighting factors correspond to the type of food (i.e. vegetables, starches, meats, etc.).

At step 220, Data is gathered relating to the eating activity of the user. Sensor 112 and processor 106, executing one or more software modules 109 including the sensor module, are configured gather information from the sensor 112 and store the data gathered by the sensor 112 in memory 108. In certain embodiments, sensor 112 is positioned adjacent the user's neck and can be a variety of different sensors. By way of example and not limitation, sensor 112 can be a strain gauge connected to a band that is worn around the user's neck such that when a swallow increases the diameter of the user's throat, tension is exerted on the strain gauge and the data generated by the strain gauge varies accordingly. The sensor 112 can also be an accelerometer that is positioned on the throat of a user that captures data relating to the movement of the user's throat as the user is swallowing. The sensor can also be an acoustic sensor that records the sound of user swallowing. The sensor 112 can be in wireless or wired communication with the control circuit 103, allowing for the sensor to be worn by the user independently of the rest of the calorie intake monitoring system 100.

At step 230, the processor 106, executing one or more software modules, is configured to analyze the sensor data recorded in memory 108 to determine whether a swallow event has occurred. The processor 106, executing software module 109 including the sensor module, compares the data from the sensor 112, to data that is stored on memory 108 that is known to correspond to a swallow event. If the sensor data matches the known swallow data, a swallow event has occurred.

If a swallow event has occurred, the processor 106 determines the caloric value of the swallow at step 240. The processor 106, executing software modules 109 including a calorie counting module, calculates the caloric value of the swallow by combining the swallow data with the weighting factor input by the user according to an algorithm. In one implementation, the caloric value of a swallow is the number of swallows recorded by the swallow monitor multiplied by the average concentration of calories in a swallow.

At step 250, a profile is updated with the swallow event data and caloric value of the most recent swallow. A profile contains various diet related information about the person such as historical calorie intake data. By example, the profile can include calorie intake related data of the user over a period of time, such as the last hour, day, or since the calorie monitor 100 was turned on. The processor 106, executing one or more software modules 109, updates the profile by incrementing the one or more various calorie intake values by the caloric value of the latest swallow. The profile can also be updated with additional information including the actual caloric value of a swallow, the weighting factor applied to the swallow, and the time when the swallow occurred.

At step 260 if the calorie intake value for a given time period exceeds a pre-defined value, a notification can be generated. The processor 106, executing software, compares the calorie intake value for one or more set periods of time, such as the last hour, or day, with a pre-defined threshold value, and if the caloric value exceeds the pre-defined limit, the user is notified by notification device 117. Notification device 117 may, by example and without limitation, vibrate, generate a sound or flash. As an alternative or supplemental to notification device 117, a user can be notified that a threshold calorie intake value has been exceeded via the display 114.

At step 270, the user's profile can be provided to the user through a portal. The portal can include, but is not limited to, an application on the person's mobile device or a web-based portal accessible through the internet. The portal can be configured to allow the user to share his/her results. This can be done through a stand-alone web page or application or via social media websites and applications such as Facebook and Twitter. The portal can also be configured to receive and log workout activity information of the user. This workout activity information can be input into the portal either manually by the user or automatically by a device that gathers physical activity data such as a pedometer.

The systems and methods are not limited in any way to the illustrated embodiments and/or arrangements as the illustrated embodiments and/or arrangements described above are merely exemplary of the systems and methods, which can be embodied in various forms, as appreciated by one skilled in the art. Therefore, it is to be understood that any structural and functional details disclosed are not to be interpreted as limiting the systems and methods, but rather are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used are not intended to be limiting, but rather are to provide an understandable description of the systems and methods. While the invention has been described in connection with certain embodiments thereof, the invention is not limited to the described embodiments but rather is more broadly defined by the recitations in any claims that follow and equivalents thereof.

1. A calorie monitoring system comprising:
a swallow sensor externally worn by a user in proximity to the user's neck and configured to detect human swallow events from movement of the user's neck and generate swallow event data for each human swallow event detected;
a user interface configured to receive a user input and generate weighting factors according to the user inputs, the weighting factors relating to the intrinsic caloric value of food;
a memory arranged to store the swallow event data and to store the generated weighting factors in association with the swallow event data;
a processor arranged to, for each human swallow event detected, process the stored data by executing code to transform the weighting factors and the swallow event data into a calorie intake value in accordance with an algorithm and store the calorie intake value in memory; and
the processor being further arranged to maintain, in memory, a profile of swallow event data, weighting factors and calorie intake values.

2. The system of claim 1, further comprising a portal arranged to publish the profile of calorie intake values.

3. The system of claim 1, further comprising a communication interface.

4. The system of claim 1, further comprising a feedback device configured to generate an alert when the calorie intake value reaches a pre-determined value.

5. The system of claim 1, wherein the swallow sensor is a strain gauge operatively connected to a band worn around a user's neck that generates data during a human swallow event.

6. The system of claim 1, wherein the monitoring device includes a switch that is triggered by the expansion of a user's neck during a human swallow event.

7. The system of claim 1, wherein the swallow sensor comprises an accelerometer that captures movement data relating to the movement of a throat during a human swallow event.

8. The system of claim 1, wherein the monitoring device further comprises an audio sensor that captures sound data during a human swallow event.

9. The system of claim 1, wherein there are two or more weighting factors that correspond to the caloric concentration of food.

10. The system of claim 1, wherein the user interface is a touch screen device.

11. The system of claim 2, wherein the portal is a smart phone application.

12. The system of claim 2, wherein the portal is a web based application.

13. A method for monitoring calorie intake of a person:
receiving swallow event data into a memory on a one or more human swallow events detected by a sensor in proximity to the person's neck from the movement of the person's neck during the one or more human swallow events;
receiving weighting factors into memory on the intrinsic caloric concentration of food, wherein the step of receiving weighting factors includes receiving a user input and generating the weighting factors according to the user input;
for each of the one or more human swallow events detected, processing the received swallow event data by executing code in a processor that configures the processor to apply the weighting factors to the swallow event data relating to the one or more human swallow events and generate a caloric value for the one or more human swallow events;
storing the caloric value to memory;
maintaining a profile with previously captured received data in the memory;
generating a notification when the caloric value reaches a pre-determined value; and
providing the profile to the user through a portal.
